(19) United States
(12) Patent Application Publication
(10) Pub. No.: US 2015/0185781 A1
(43) Pub. Date: Jul. 2, 2015

(54) DISPLAY DEVICE

(71) Applicant: SAMSUNG DISPLAY CO., LTD., Yongin-City (KR)

(72) Inventors: Sunmi Yu, Yongin-si (KR); MuGyeom Kim, Hwaseong-si (KR); Hyun Jae Lee, Seoul (KR)

(21) Appl. No.: 14/481,872

(22) Filed: Sep. 9, 2014

(30) Foreign Application Priority Data
Dec. 27, 2013 (KR) 10-2013-0165571

(51) Int. Cl. G06F 1/16; G09G 5/00; G09G 5/37; G06F 3/041

(52) U.S. Cl. CPC G06F 1/1652; G06F 1/163; G06F 1/1643; G06F 3/0412; G09G 5/003; G09G 5/37; G09G 2380/02; G09G 2320/10; G09G 2320/08

(57) ABSTRACT

A display device including a display part displaying an image corresponding to one operation mode selected from a first operation mode and a second operation mode, selected according to a shape. The display part displays the image on a partial area when the first operation mode is selected. The display part displays the image on the partial area and another area adjacent to the partial area when the second operation mode is selected.

### CROSS-REFERENCE TO RELATED APPLICATION

This patent application claims priority to and the benefit of Korean Patent Application No. 10-2013-0165571, filed on Dec. 27, 2013, the entire content of which is hereby incorporated by reference.

### BACKGROUND

An aspect of an embodiment of the present invention disclosed herein relates to a display device, and more particularly, to a display device displaying various images according to modified shapes.

Display devices provide users with information by displaying various images on a display screen. Generally, display devices display information within an allocated screen. Currently, flexible display devices including a flexible display panel capable of being bent have been developed. Flexible displays, different from flat panel displays, may be folded, rolled up, or bent as paper. As such, it is possible to carry flexible displays that are variously modifiable in shape without limitations in size of its screen, thereby improving convenience of users.

### SUMMARY

An aspect of an embodiment of the present invention provides a display device capable of being modifiable in shape and variously displaying images according to the modified shape.

Embodiments of the present invention provide display devices including a display part displaying an image corresponding to one of a first operation mode and a second operation mode, selected according to a shape. In this case, the display part displays the image on a partial area when the first operation mode is selected, and the display part displays the image on the partial area and another area adjacent to the partial area when the second operation mode is selected.

In some embodiments, the display part may operate in the first operation mode when having a bent shape. Also, the display part may operate in the second operation mode when having an unfolded shape.

In other embodiments, the display part may include a main area and at least one sub-area adjacent to the main area. In this case, the first operation mode may be selected when the at least one sub-area is bent from the main area.

In still other embodiments, when the display part operates in the first operation mode, the main area may be activated and may display a first image providing first information and the sub-area may be deactivated and may not display an image.

In even other embodiments, when the display part operates in the second operation mode, the main area and the sub-area may be activated and may display a second image providing second information.

In yet other embodiments, the first image and the second image may provide independent information from each other.

In further embodiments, the display part may include a flexible display panel and a touch panel disposed on a top of the flexible display panel and sensing an external touch.

In still further embodiments, the display device may further include a shape modifier disposed below the display part and modifying a shape of the display part according to an inputted shape modification signal. In this case, the shape modifier may include an electroactive polymer (EAP) material contracting according to an applied operation voltage.

In even further embodiments, the shape modifier may include a first section overlapped with the main area and a second section overlapped with the sub-area. In this case, concentration of the EAP material in the second section may be greater than concentration of the EAP material in the first section to allow the second section to contract more than the first section to bend the shape of the display part when the operation voltage corresponding to the shape modification signal is applied to the first section and the second section.

In yet further embodiments, the display device may further include an operation sensor sensing operation information of a user for modifying the shape of the display part. In this case, the operation sensor may provide the shape modifier with the shape modification signal corresponding to the sensed operation information.

In much further embodiments, the operation sensor may include a touch sensor disposed below the display part, and the touch sensor may generate the shape modification signal when a touch is maintained for a certain time.

In still much further embodiments, the operation sensor may include a gravitational sensor, and the gravitational sensor may generate the shape modification signal when the display device keeps rotating in one direction for a certain time.

In even much further embodiments, the operation sensor may include a strain sensor, and the strain sensor may generate the shape modification signal when stress applied to at least one part of the display part is kept for a certain time.

In yet much further embodiments, the display device may further include at least one peripheral part connected to the display part. In this case, the peripheral part may be connected to the display part along a direction, in which the main area and the sub-area are connected.

In further embodiments, one side of the peripheral part may be connected to one side of the display part and another end thereof may be connected to another side of the display part to allow the peripheral part and the display part to form a looped curve.

In other embodiments of the present invention, display devices include a display part displaying images corresponding to one of a first operation mode and a second operation mode, selected according to a modification of a shape. In this case, a first image displayed in the first operation mode and a second image displayed in the second operation mode provide independent information from each other.

In some embodiments, the display part may operate in the first operation mode when the display part is in a bent shape. Also, the display part may operate in the second operation mode when the display part is in an unfolded shape.

In other embodiments, the display part may include a main area and at least one sub-area adjacent to the main area. In this case, the display device may further include at least one peripheral part connected to the display part along a direction, in which the main area and the sub-area are connected.

In other embodiments, when the display part operates in the first operation mode, the main area may display the first image providing first information and the sub-area may display a third image providing second information different from the first information.

In other embodiments, when the display part operates in the second operation mode, the second image may provide one piece of information and the main area may display an image that is a part of the second image and the sub-area may display other parts of the second image.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1A is a perspective view of a display device according to an embodiment of the present invention;

FIG. 1B is a perspective view of a display device according to another embodiment of the present invention;

FIG. 2 is another perspective view of the display device of FIG. 1;

FIGS. 3A and 3B are perspective views illustrating states of using (utilizing) the display device of FIG. 1;

FIG. 4 is a side view illustrating a display type according to a shape of the display device of FIG. 1;

FIGS. 5A to 5C are perspective views of a display part according to the shape of the display device of FIG. 1;

FIG. 6 is a block diagram illustrating components for driving the display device of FIG. 1;

FIG. 7 is a cross-sectional view of the display part of FIG. 5A;

FIGS. 8A and 8B are partial perspective views of the display part of FIG. 5A; and

FIGS. 9A and 9B are flowcharts illustrating operations of modifying an operation mode of the display device of FIG. 1.

### DETAILED DESCRIPTION

Hereinafter, embodiments of the present invention will be described in more detail.

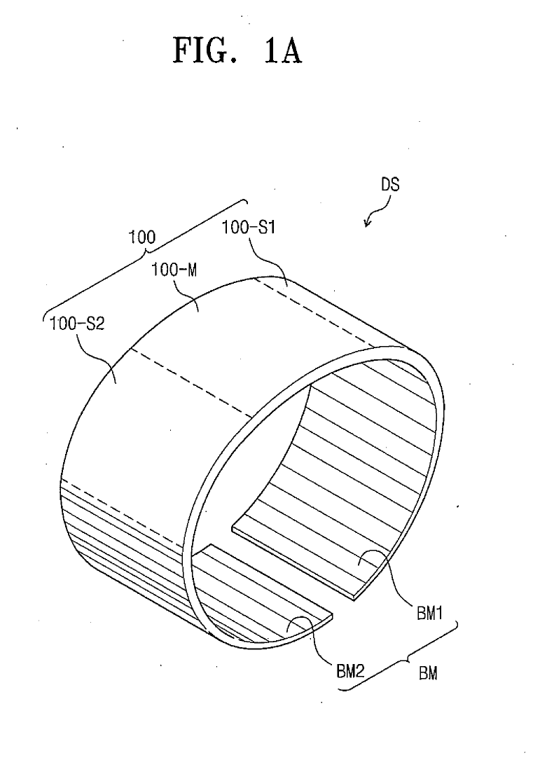

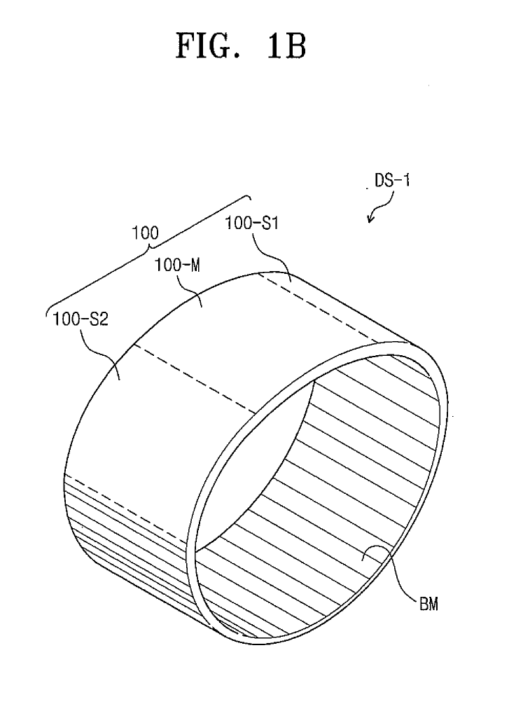

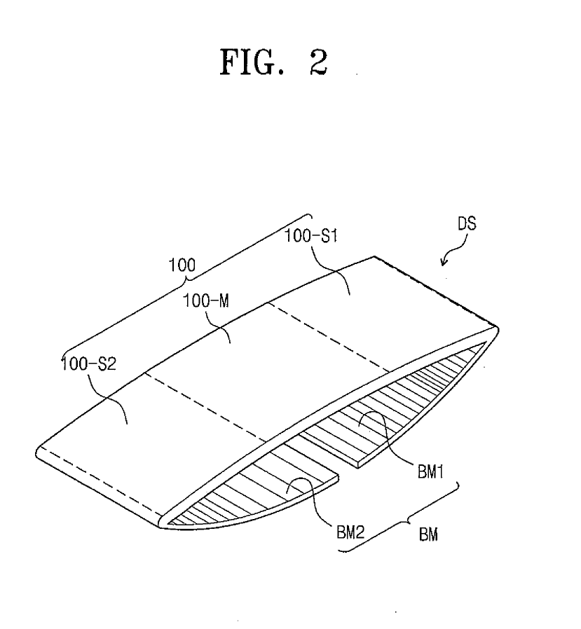

FIG. 1A is a perspective view of a display device DS according to an embodiment of the present invention. FIG. 1B is a perspective view of a display device DS-1 according to another embodiment of the present invention, and FIG. 2 is another perspective view of the display device DS. FIGS. 1A and 1B illustrate bent shapes of the display devices DS and DS-1, respectively. FIG. 2 illustrates the display device DS that is partially bent.

As shown in FIGS. 1A and 2, the display device DS includes a display part 100 and a peripheral part BM. The display device DS-1 shown in FIG. 1B has the same configuration as the display device DS of FIG. 1A except a shape of the peripheral part BM. On the other hand, not shown in FIGS. 1A to 2, the display devices DS and DS-1 may further include other components in addition to the display part 110 and the peripheral part BM.

As shown in FIGS. 1A and 2, the display part 100 includes a main area 100-M and at least one sub-area. In the present embodiment, the display part 100 includes a plurality of sub-areas 100-S1 and 100-S2. The plurality of sub-areas 100-S1 and 100-S2 are adjacent to one side and another side of the main area 100-M, respectively.

The display device DS may be modified as various shapes. The display part 100 displays images corresponding to an operation mode selected according to the shape of the display device DS. The shape of the display device DS may vary with a shape of the display part 100. The shape of the display part 100 may be determined according to degrees of being bent of the main area 100-M and the sub-areas 100-S1 and 100-S2, respectively.

As shown in FIG. 1A, when the main area 100-M and the sub-areas 100-S1 and 100-S2 have curved surfaces, respectively, the display part 100 may have a bent shape. Merely, in other embodiments, any one of the main area 100-M and the sub-areas 100-S1 and 100-S2 may be flat. For example, the main area 100-M has a flat surface and at least one of the sub-areas 100-S1 and 100-S2 may have a curved surface. In this case, the sub-areas 100-S1 and 100-S2 are bent from the main area 100-M.

Otherwise, as shown in FIG. 2, when the main area 100-M and the sub-areas 100-S1 and 100-S2 have flat surfaces, respectively, the display part 100 may have an unfolded shape. In this case, the sub-areas 100-S1 and 100-S2 are unfolded from the main area 100-M.

In the present embodiment, each of the plurality of sub-areas 100-S1 and 100-S2 is unfolded from the main area 110-M or bent downwards. The sub-areas 100-S1 and 100-S2 are not limited to a certain angle with the main area 100-M and may be bent at various angles. Also, the sub-areas 100-S1 and 100-S2 may be bent at different angles from each other.

For example, as shown in FIGS. 1A and 1B, at least one part of the display part 100 has a bent shape. The display device DS operates in a first operation mode. In the first operation mode, at least one part of the display part 100 is activated. The at least one part includes the main area 100-M. In the first operation mode, the image may be displayed on at least the main area 100-M.

Also, as shown in FIG. 2, when the display part 100 has an unfolded shape, the display device DS operates in a second operation mode. In the second operation mode, the display part 100 is additionally activated in other areas adjacent to the at least one part. For example, in the second operation mode, the display part 100 displays the image through the main area 100-M and at least one sub-area.

The peripheral part BM is connected to the display part 100. The peripheral part BM is connected to the display part 100 in the same direction, in which the main area 100-M is connected to the sub-areas 100-S1 and 100-S2.

As shown in FIGS. 1A and 2, the peripheral part BM may include a plurality of sections BM1 and BM2. The plurality of sections BM1 and BM2 are connected to the sub-areas 100-S1 and 100-S2, respectively. In this case, the display part 100 may be extended to a part of the sub-areas 100-S1 and 100-S2.

As shown in FIG. 1A, the plurality of sections BM1 and BM2 may be separately disposed. A gap between the plurality of sections BM1 and BM2 may decrease or increase as the shape of the display device DS is modified.

The peripheral part BM may be bent or unfolded according to the shape of the display part 100. The peripheral part BM is formed of a material having flexibility. The peripheral part BM includes the same configuration of the display part 100 and may be formed together with the display part 100 as a single body.

Otherwise, the peripheral part BM may include a material more flexible than the display part 100. Alternatively, the peripheral part BM may include any one of plastic, rubber, and fabric and may be connected to the display part 100 using (utilizing) a connector such as a hinge.

Although not shown in the drawing, a fastening member (not shown) is further included in the gap and may connect the plurality of sections BM1 and BM2 to each other. The plurality of sections BM1 and BM2 are connected to the fastening member and may be controlled in length. In the display device DS, a user may control a length of the peripheral part BM to be easily fixed to a desirable position.

Alternatively, as shown in FIG. 1B, the display device DS-1 may include the peripheral part BM connected as a single body. The peripheral part BM may form one looped curve together with the display part 100. The display device DS-1 may be bent or unfolded as a single body in the first operation mode or the second operation mode.

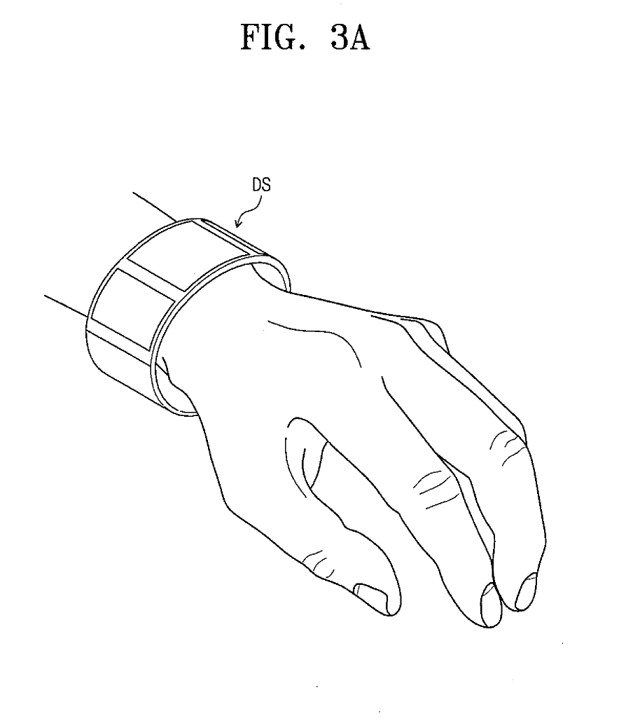

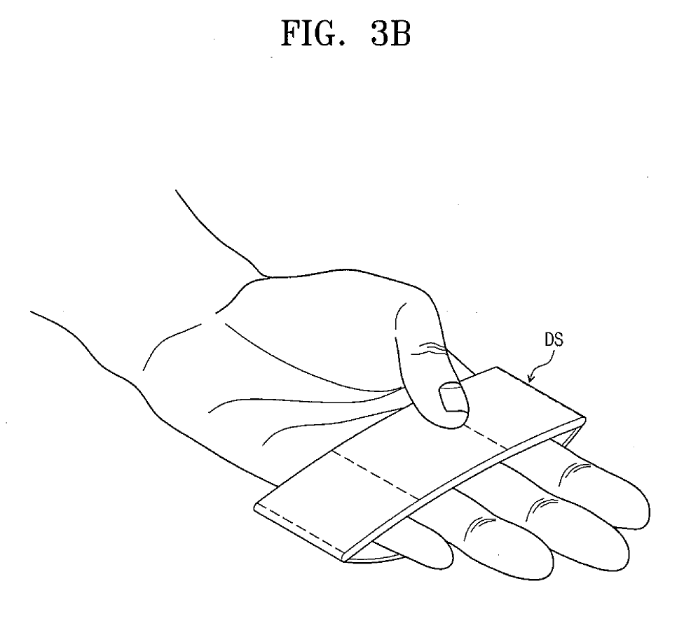

FIGS. 3A and 3B are perspective views illustrating states of using the display device DS. In FIGS. 3A and 3B, among various embodiments, a smart watch will be described. However, this is just an example, and the display device DS is not limited to any one embodiment.

As shown in FIG. 3A, the display device DS may operate in the first operation mode when being worn on a wrist of the user. The display device DS is attached and fixed to the wrist of the user in a bent shape.

As shown in FIG. 3B, the display device DS may operate in the second operation mode when being used on a palm of the user. The display part 100 of the display device DS is disposed on the palm of the user in an unfolded shape.

Accordingly, when using the display device DS on the palm, the user receives information on a relatively wider display screen than wearing the display device DS on the wrist.

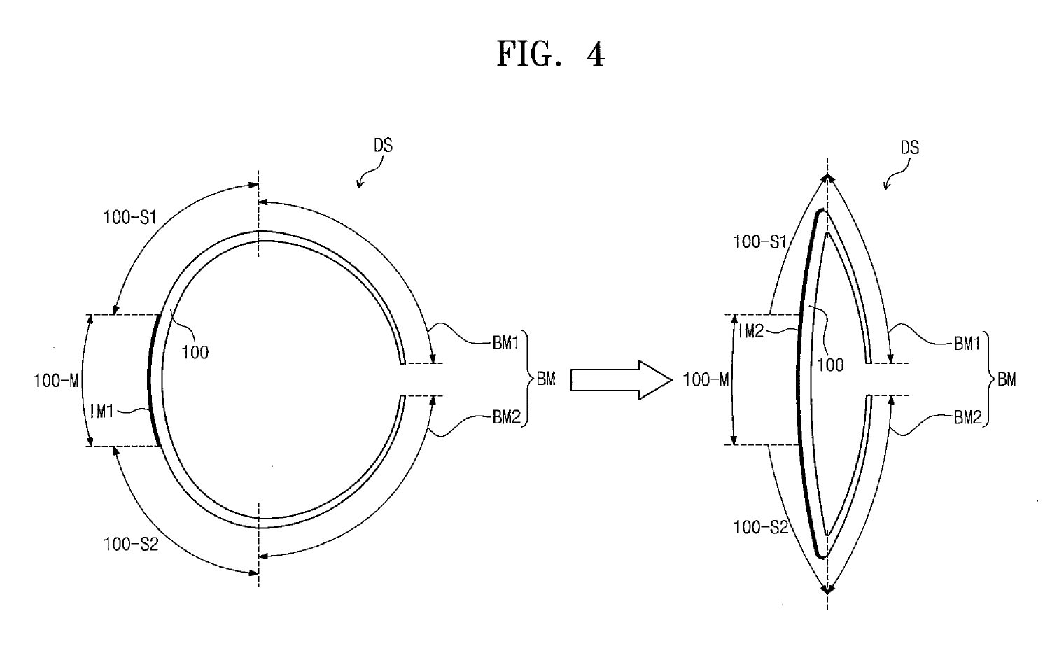

FIG. 4 is a side view illustrating a display type according to the shape of the display device DS. In the left of FIG. 4, an area activated in the first operation mode is schematically illustrated. In the right of FIG. 4, an area activated in the second operation mode is schematically illustrated.

The display part 100 outputs information processed by the display device DS. The display part 100 may display various images by receiving electric signals corresponding to the operation modes. FIG. 4 shows a change in area between the images displayed by the display device DS according to the operations modes.

As shown in the left of FIG. 4, when the display part 100 operates in the first operation mode, the display part 100 is activated in an area and is deactivated in another area. For example, the main area 100-M is activated and displays a first image IM1 providing first information. The first information may be main information mainly recognized by the user. The user is provided with the main information through the first image IM1.

The display part 100 operating in the first operation mode displays an image on at least the main area 100-M. For example, the image displayed on the main area 100-M may provide relatively more simple information such as time, weather, etc. or partial information of one complete (perfect) information. Although not shown in the drawing, in other embodiments, at least one of the sub-areas 100-S1 and 100-S2 is activated and displays an image.

As shown in the right of FIG. 4, when the display part 100 operates in the second operation mode, at least one of the sub-areas 100-S1 and 100-S2 may be additionally activated in addition to the main area 100-M. The area activated in the second operation mode is broader than the area activated in the first operation mode.

The display part 100 displays a second image IM2 providing second information when operating in the second operation mode. For example, the second image IM2 displayed in the second operation mode may be displayed in the entire area of the display part 100.

The second image IM2 provides information independent from the first image IM1. The second image IM2 may provide the main information mainly recognized by the user. The second image IM2 is provided in an area relatively broader than the first image IM1. The user may use the entire area of the display part 100 and may receive major information from the second image IM2.

As shown in FIG. 4, the operation modes may freely change without limitation. The first operation mode may be changed into the second operation mode, and the second operation mode may be changed into the first operation mode. The display device DS may select various modes according to shapes. A different image in activated area according to the selected mode may be provided.

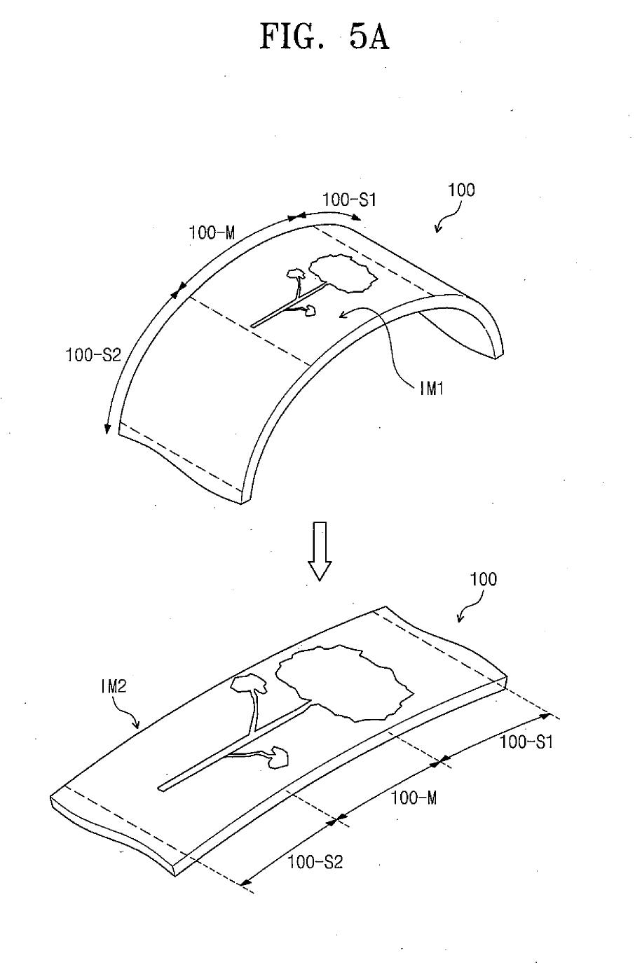

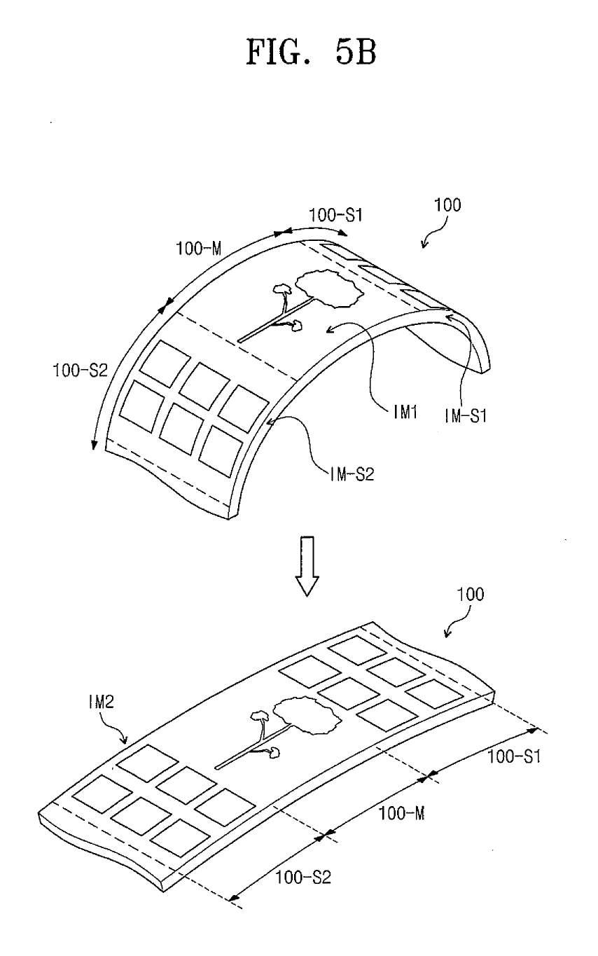

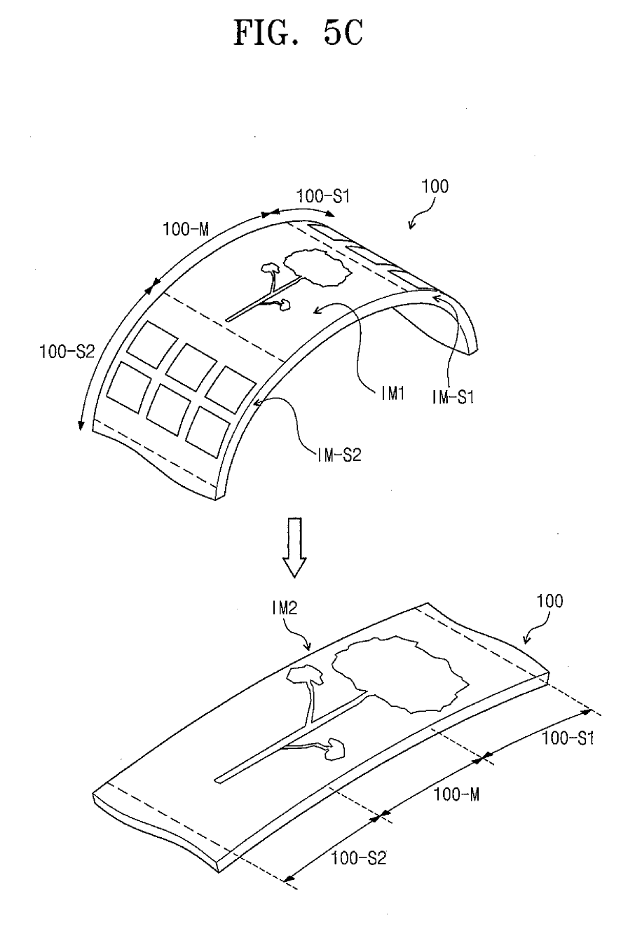

FIGS. 5A to 5C are perspective views of the display part 100 according to the shape of the display device of DS. Hereinafter, referring to FIGS. 5A to 5C, images displayed by the display device DS according to the operation modes will be described.

As shown in FIG. 5A, when the display part 100 operates in the second operation mode, only the main area 100-M may be activated, and when the display part 100 operates in the second operation mode, the main area 100-M and the plurality of sub-areas 100-S1 and 100-S2 may be activated.

Accordingly, the first image IM1 is displayed on the main area 100-M, and the second image IM2 is displayed on the main area 100-M and the sub-areas 100-S1 and 100-S2. The first image IM1 and the second image IM2 may have independent information from each other.

The second image IM2 may provide information formed by resizing the first image IM1. For example, when the display part 100 operates in the second operation mode, a more enlarged image than an image provided in the first operation mode may be provided. The user may easily receive information through the enlarged image in the second operation mode.

Otherwise, as shown in FIG. 5B, the main area 100-M and at least one sub-area may be activated at the same time in the first operation mode. In this case, the main area 100-M displays the first image IM1 and activated one(s) of the sub-areas 100-S1 and 100-S2 may display a third image IM3.

The third image IM3 provides information different from the first image IM1. For example, the third image IM3 may display icons necessary for driving the display device DS. The first image IM1 becomes the main information, and the third image IM3 may be sub-information. The user may receive the major information from the main area 100-M and may receive subsidiary information from the sub-areas 100-S1 and 100-S2 in the first operation mode.

The display part 100 may display the image displayed in the first operation mode as the second image IM2 in the second operation mode. The user may recognize the recognized image regardless of a modification in shape.

Alternatively, although not shown in the drawing, the first image IM1 may be a partial image of the second image IM2. Accordingly, when operating in the second operation mode, the display part 100 may provide a complete entire image of the image provided in the first operation mode. The second image IM2 includes partial information unrecognizable from the first image IM1 or information recognized through operations such as scrolling. Accordingly, the user may receive more perfect or complete information in the second operation mode than the first operation mode.

Alternatively, in the second operation mode, the display part 100 may display a part of the image displayed in the first operation mode. As shown in FIG. 5C, the second image IM2 may selectively provide the information provided by the first image IM1 among the first image IM1 and the third image IM3 displayed in the first operation mode. The second image IM2 may provide the partial information as it is or may provide the resized thereof.

Here, the above provided embodiments are just examples. The second image IM2 may provide information identical to or different from the first image IM1 and is not limited thereto. Since the display part 100 may provide various display types according to the operation modes, the user may use the display device DS to display the various display types that may be available.

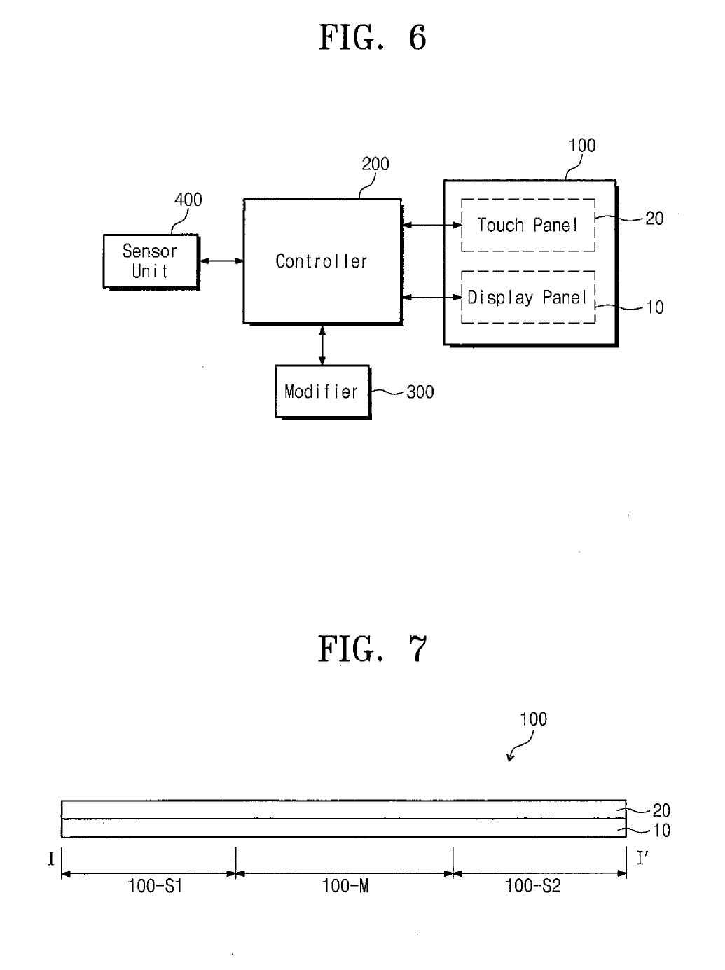

FIG. 6 is a block diagram illustrating components for driving the display device DS. Referring to FIG. 6, functions of the display device DS will be described. As shown in FIG. 6, the display device DS functionally includes the display part 100, a controller 200, a modifier 300, and a sensor part 400.

The display part 100 includes a display panel 10 and a touch panel 20. The display panel 10 includes a substrate, signal wirings disposed on the substrate, and pixels electrically connected to the signal wirings. The pixels generate an image based on signals received from the signal wirings.

The display panel 10 may be a flexible display panel that is both relatively pliable and slim. The flexible display panel 10 may be one of an organic light emitting display (OLED) panel, electrophoretic display panel, and electrowetting display panel. The display panel 10 may be bent or rolled to entirely form a curved surface.

The touch panel 20 senses an external touch and provides the controller 200 with a touch signal. The touch signal includes information of a point of the display panel 10, which the user touches.

The controller 200 controls the entire operations of the display device DS by generally controlling operations of the respective components forming the display device DS. For example, the controller 200 modifies the shape of the display device DS, modifies and processes displayed images, and activates or deactivates the display panel 10 and the touch panel 20.

The controller 200 may control the display part 100, the modifier 300, and the sensor part 400. Signals are received from the components included in the display device DS or signals for controlling the components are outputted. The display device DS may be driven through signal transmission between the controller 200 and the respective components.

For example, the controller 200 converts a shape modification signal inputted from the sensor part 400 into a corresponding operation voltage and provides the modifier 300 with the operation voltage. Also, the controller 200 converts an image signal into image data according to the shape of the display part 100 and outputs the image data on the display panel 10.

The modifier 300 modifies the shape of the display part 100. The modifier 300 receives the shape modification signal from the controller 200 and modifies the shape of the display part 100.

The modifier 300 may include an electro-responsive medium. In the modifier 300, the electro-responsive medium is cornered into any one side or contracts according to a direction of a current, thereby generating a bending force for modifying the shape of the display part 100.

The electric response medium may include various materials. For example, the electro-responsive medium may include one of electroactive polymers (EAP), electroactive ceramic, a dielectric actuator, and relaxor ferroelectric polymers. Also, the EAP may be ionic electro-responsive polymers.

The sensor part 400 senses an external signal for modifying the shape of the display device DS. The sensor part 400 senses a present state of the display device DS and generates a sensing signal for controlling the operations of the display device DS. The sensor part 400 senses a physical state of the display device DS and provides the controller 200 with a signal corresponding to the sensed state.

The sensor part 400 may include an operation sensor (not shown). The operation sensor senses user operation information for modifying the shape of the display part 100.

The operation sensor generates the shape modification signal corresponding to the sensed operation information. The shape modification signal is provided to the controller 200, thereby modifying the shape of the display part 100. The display part 100 provides an image corresponding to the shape.

When the sensor part 400 senses a certain external operation for modifying the shape of the display device DS, the modifier 300 modifies the shape of the display device DS and the display part 100 displays an image according to an operation mode. Here, in other embodiments, the sensor part 400 may be omitted.

FIG. 7 is a cross-sectional view of the display part 100. As shown in FIG. 7, the touch panel 20 may be disposed on a top of the display panel. Although not shown in the drawing, the touch panel 20 may be provided as a touch pad patterned on the display panel 10 to be formed together with the display panel 10 as a single body.

Although not shown in the drawing, a protection layer may be further disposed on a top of the display part 100. The protection layer protects a top surface of the display part 100. The protection layer may be formed of a transparent material and may further include an antireflective material for decreasing reflectance of external lights.

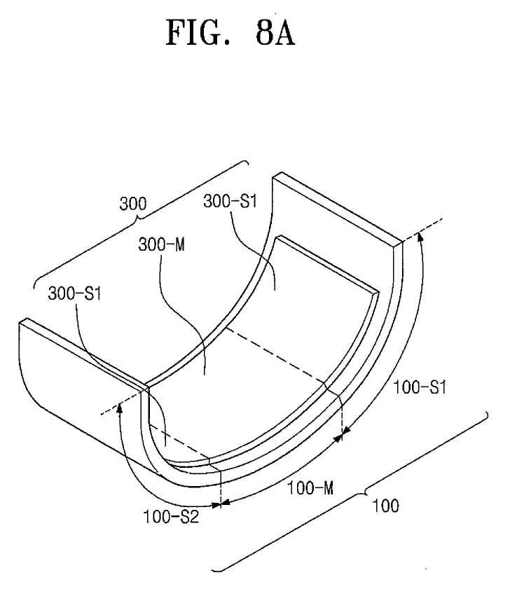

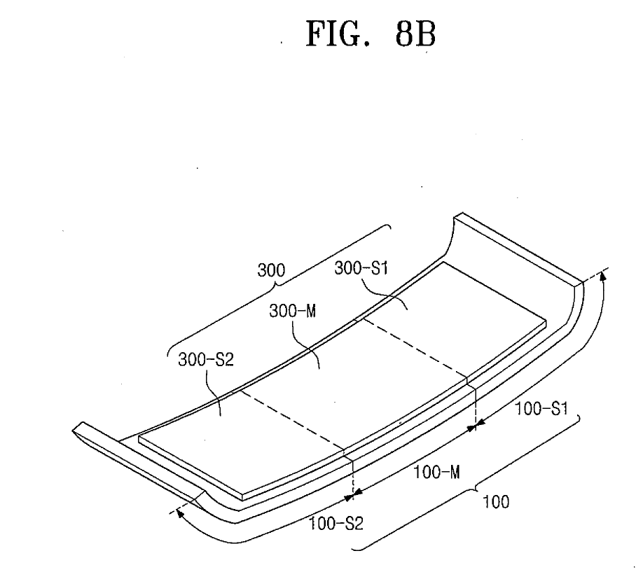

FIGS. 8A and 8B are perspective views illustrating a part of the display device DS. FIGS. 8A and 8B illustrate a bottom of the display part 100. On the other hand, in FIGS. 8A and 8B, it will be described as an example that the modifier 300 includes the electro-responsive medium.

As shown in FIGS. 8A and 8B, the modifier 300 may be divided into a plurality of sections. The plurality of sections include a first section 300-M and second sections connected to the first section 300-M. In the present embodiment, the modifier 300 includes a plurality of second sections 300-S1 and 300-S2.

The plurality of sections 300-S1 and 300-S2 may correspond to the areas of the display part 100, respectively. For example, the first section 300-M may be overlapped with the main area 100-M and the second sections 300-S1 and 300-S2 may be overlapped with the sub-areas 100-S1 and 100-S2, respectively.

The plurality of sections 300-M, 300-S1, and 300-S2 may be different in flexibility. A degree (e.g., level or extent) of being bent of the display part 100 may vary with (e.g., may vary depending on) the flexibility of the plurality of sections 300-M, 300-S1, and 300-S2. For example, the flexibility of the respective second sections 300-S1 and 300-S2 may be greater than the first section 300-M.

As shown in FIG. 8A, the degree of being bent of the display part 100 is greatly influenced by degrees of being bent of the sub-areas 100-S1 and 100-S2. The display part 100 is bent or unfolded by a bending force of the modifier 300. Accordingly, a bending force of the second sections 300-S1 and 300-S2 corresponding to the sub-areas 100-S1 and 100-S2 may be relatively greater than a bending force of the first section 300-M.

For example, when the electro-responsive medium includes positive ions, the electro-responsive medium is driven to a part, to which minus polarity is applied, a volume of the part applied with minus polarity expands, and a part applied with plus polarity contracts, thereby bending the modifier 300.

The display device DS may control the degree of being bent of the modifier 300 by varying concentration of the EAP for each section of the modifier 300. As the concentration or distribution of the EAP is greater, a contracting force may become greater and a bending force may become greater. Accordingly, the concentration of the EAP may be greater in the first section 300-M than in the second sections 300-S1 and 300-S2.

Also, although not shown in the drawing, in the sections, the concentration of the EAP may not be uniform. For example, the concentration of the EAP in the respective second sections 300-S1 and 300-S2 may become greater while moving toward (becoming more adjacent to) the first section 300-M. Also, in the first section 300-M, the concentration of the EAP may become greater while moving toward (becoming more adjacent to) the second sections 300-S1 and 300-S2.

As shown in FIG. 8B, when the operation voltage of a reference voltage or less is applied to the modifier 300, the direction of the current flowing through the modifier 300 varies. According thereto, the EAP included in the modifier 300 start to move. The second sections 300-S1 and 300-S2 contracting in the first operation mode are relaxed to allow the display part 100 to have an unfolded shape.

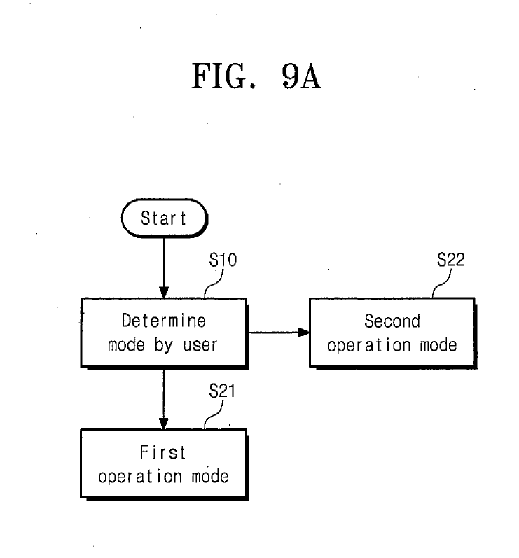

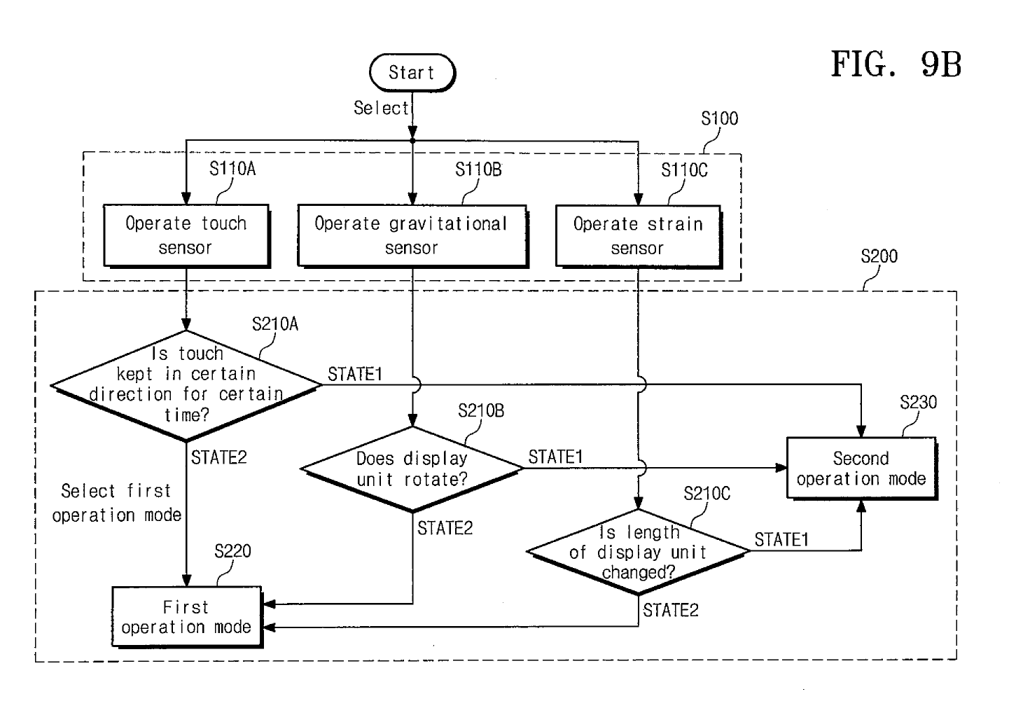

FIGS. 9A and 9B are flowcharts illustrating operation mode modification operations of the display device DS. As shown in FIG. 9A, the operation mode of the display device DS may be modified by a direct operation of the user. For example, the display device DS may further include an additional input part and the user may change the display device DS into the first operation mode (S21) or the second operation mode (S22) by selecting one of the operation modes via a switch SW.

In this case, the operation mode of the display device DS is changed by the direct setting of the user and the display device DS does not include an additional operation sensor. In the display device DS, the shape of the display part 100 is changed according to the selection and an image corresponding to the operation mode is displayed.

As shown in FIG. 9B, in the display device DS, the operation modes may be changed through the sensor part 400 (refer to FIG. 6). An operation of changing the operation mode includes initiating the operation sensor (S100) and sensing user operation information (S200).

The initiating of the operation sensor (S100) includes turning on the operation sensor included in the display device DS. The initiating of the operation sensor (S100) may vary with the operation sensor included in the display device DS.

The initiating of the operation sensor (S100) may be operating a touch sensor (S110A). In this case, the operation sensor may be a touch sensor. The touch sensor may recognize the operation information of the user through whether a touch is sensed for a certain time (S210A). The touch sensor recognizes an operation of the user to move the display device DS for a certain time.

For example, when the display device DS is used as a smart watch, the touch may be a drag of a wrist or a palm of the user. Transferring the display device DS located on the wrist to the palm may be received as operation information for converting the first operation mode into the second operation mode. Also, pushing the display device DS used on the palm to the wrist may be received as operation information for converting the second operation mode into the first operation mode.

When the operation information is sensed, the display part 100 determines when to enter an operation mode different from a previous operation mode and modifies a shape and a displayed image. Accordingly, when the previous mode is the first operation mode (STATE1), the display device DS is converted into the second operation mode (S230), and when the previous mode is the second operation mode (STATE2), the display device DS is converted into the first operation mode (S220).

Alternatively, the operation sensor may be a gravitational sensor sensing gravitation. The gravitational sensor attached to the display part 100 may recognize the operation information of the user through whether the display part 100 rotates (S210B). When the display device DS is used as a smart watch, the gravitational sensor recognizes an operation of turning the display device DS.

For example, turning of the display device DS located on the wrist or turning of the wrist may be received as operation information for converting the first operation mode into the second operation mode. Also, turning the display device DS used on the palm or turning the palm may be received as operation information for converting the second operation mode into the first operation mode. In one embodiment, the gravitational sensor includes a gyro sensor.

When the operation information is sensed, the controller 200 receives a gravitational direction and angle information, in which the display device DS relatively rotates toward the gravitational direction. When the operation information is sensed, the display device DS determines when to enter an operation mode different from a previous operation mode and modifies the shape of the display part 100 and an image displayed on the display part 100. Accordingly, when the previous mode is the first operation mode (STATE1), the display device DS is converted into the second operation mode (S230), and when the previous mode is the second operation mode (STATE2), the display device DS is converted into the first operation mode (S220).

The initiating of the operation sensor (S100) may be operating a strain sensor (S110C). In this case, the operation sensor may be a strain sensor. The strain sensor may recognize the operation information of the user through whether at least one area of the display part 100 changes in length (S210C). For example, the strain sensor senses a certain modification caused by folding or bending a part of the display part 100.

The change in length may be generated by stress provided to the at least one part. The strain sensor recognizes an operation of modifying the shape of the display device DS, performed by the user, as the operation information of the user. That is, the operation of modifying a part of the display device DS by applying a force on the outside of the display device DS may be received as operation information for converting a present operation mode into a different operation mode. For example, when operating in the first operation mode (STATE1), the display device DS is converted into the second operation mode (S230). When receiving the operation information while operating in the second operation mode (STATE2), the display device DS is converted into the first operation mode (S220).

Although not shown in the drawing, the operation sensor may recognize whether the user applies a force to the display device DS, which is sensed by the operation sensor using a pressure sensor, as operation information for converting into the operation mode. Alternatively, the operation sensor may recognize a change in electrostatic capacitance near a proximity sensor, which is sensed using the proximity sensor, as the operation information of the user. The operation sensor may use various sensors and is not limited to any one example.

As described above, according to the one or more of the above embodiments of the present invention, a display device may determine an operation mode from an operation of a user. According to the operation of the user, a shape of the display device may be modified and the display device may provide the user with an image corresponding to the modified shape. Accordingly, convenience of operating the display device may be improved.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A display device comprising:
a display part configured to display an image corresponding to one operation mode selected from a first operation mode and a second operation mode based on a shape,
wherein the display part is configured to display the image on a partial area when the first operation mode is selected, and
wherein the display part is configured to display the image on the partial area and another area adjacent to the partial area when the second operation mode is selected.

2. The display device of claim 1, wherein the display part is configured to operate in the first operation mode when having a bent shape, and
wherein the display part is configured to operate in the second operation mode when having an unfolded shape.

3. The display device of claim 2, wherein the display part comprises:
a main area; and
at least one sub-area adjacent to the main area,
wherein the first operation mode is selected when the at least one sub-area is bent from the main area.

4. The display device of claim 3, wherein, when the display part operates in the first operation mode, the main area is configured to be activated and to display a first image providing first information and the sub-area is configured to be deactivated and to not display an image.

5. The display device of claim 4, wherein, when the display part operates in the second operation mode, the main area and the sub-area are configured to be activated and to display a second image providing second information.

6. The display device of claim 5, wherein the first image and the second image provide independent information from each other.

7. The display device of claim 2, wherein the display part comprises:
a flexible display panel; and
a touch panel disposed on a top of the flexible display panel and configured to sense an external touch.

8. The display device of claim 7, further comprising a shape modifier disposed below the display part and configured to modify a shape of the display part according to an inputted shape modification signal,
wherein the shape modification comprises an electroactive polymer (EAP) material configured to contract according to an applied operation voltage.

9. The display device of claim 8, wherein the shape modification part comprises:
a first section overlapping with the main area; and
a second section overlapping with the sub-area,
wherein concentration of the EAP material in the second section is greater than concentration of the EAP material in the first section to allow the second section to contract more than the first section to bend the shape of the display part when the operation voltage corresponding to the shape modification signal is applied to the first section and the second section.

10. The display device of claim 9, further comprising an operation sensor configured to sense operation information of a user for modifying the shape of the display part,
wherein the operation sensor is configured to provide the shape modifier with the shape modification signal corresponding to the sensed operation information.

11. The display device of claim 10, wherein the operation sensor comprises a touch sensor disposed below the display part, and
wherein the touch sensor is configured to generate the shape modification signal when a touch is maintained for a certain time.

12. The display device of claim 10, wherein the operation sensor comprises a gravitational sensor, and
wherein the gravitational sensor is configured to generate the shape modification signal when the display device keeps rotating in one direction for a certain time.

13. The display device of claim 10, wherein the operation sensor comprises a strain sensor, and
wherein the strain sensor is configured to generate the shape modification signal when stress applied to at least one part of the display part is kept for a certain time.

14. The display device of claim 2, further comprising at least one peripheral part connected to the display part,
wherein the peripheral part is connected to the display part along a direction, in which the main area and the sub-area are connected.

15. The display device of claim 14, wherein one side of the peripheral part is connected to one side of the display part and another end thereof is connected to another side of the display part to allow the peripheral part and the display part to form a looped curve.

16. A display device comprising:
a display part configured to display images corresponding to one of a first operation mode and a second operation mode, selected according to a modification of a shape,
wherein a first image displayed in the first operation mode and a second image displayed in the second operation mode provide independent information from each other.

17. The display device of claim 16, wherein the display part is configured to operate in the first operation mode when the display part is in a bent shape, and wherein the display part is configured to operate in the second operation mode when the display part is in an unfolded shape.

18. The display device of claim 17, wherein the display part comprises:
a main area; and
at least one sub-area adjacent to the main area,
the display device further comprising at least one peripheral part connected to the display part along a direction, in which the main area and the sub-area are connected.

19. The display device of claim 18, wherein, when the display part operates in the first operation mode, the main area is configured to display the first image providing first information and the sub-area is configured to display a third image providing second information different from the first information.

20. The display device of claim 18, wherein, when the display part operates in the second operation mode, the second image is configured to provide one piece of information and the main area is configured to display an image that is a part of the second image and the sub-area is configured to display other parts of the second image.
